(19) United States
(12) Patent Application Publication
(10) Pub. No.: US 2002/0094234 A1
(43) Pub. Date: Jul. 18, 2002

(54) Handle retaining structure

(76) Inventor: Anthony Shaw, Taichung (TW)

Correspondence Address: BROWDY AND NEIMARK, P.L.L.C., 624 NINTH STREET, NW, SUITE 300, WASHINGTON, DC, 20001-5303, US

(21) Appl. No.: 09/785,221

(22) Filed: Feb. 20, 2001

(30) Foreign Application Priority Data
Jan. 12, 2001 (TW) 90200031

(51) Int. Cl. F16B 2/00; B25G 3/20

(52) U.S. Cl. 403/373

(57) ABSTRACT

A handle retaining structure comprises a handle with a first retaining portion, a fastening seat with a first carrying seat for receiving the first retaining portion, a locating device joined with the fastening seat and composed of a joining portion, a second retaining portion, and an adjustment portion. The joining portion has a second carrying seat for receiving the first retaining portion. The second retaining portion and the first retaining portion are enabled by the adjustment portion to engage or disengage with each other.

### FIELD OF THE INVENTION

The present invention relates generally to an exercise device, and more particularly to a handle retaining structure.

### BACKGROUND OF THE INVENTION

As shown in FIG. 1, a prior art handle retaining structure 1 is fastened with a support rod 5 of an exercise device and is formed of a handle 2, a press seat 3, and a screw 4.

The handle 2 has a first retaining portion 2a and is provided in periphery with a plurality of protruded strips 2b. The press seat 3 is a hollow iron ring and is fastened with the support rod 5. The press seat 3 has a second retaining portion 3a which is provided with a plurality of slots 3b. The press seat 3 further has an opening 3c and two lugs 3d extending from two ends of the opening 3c. The lugs 3d have a lock hole 3e. The handle 2 is disposed in the press seat 3 such that the first retaining portion 2a is engaged with the second retaining portion 3a. The screw 4 is received in the lock hole 3e for tightening the retaining portions 2a and 3a.

The prior art is defective in design in that the strips 2b and the slots 3b are not deep enough to ensure a secure engagement, thereby resulting in the axial slide or radial rotation of the handle 2. The handle 2 must be angularly adjusted from time to time. The screw 4 must be tightened or loosened, thereby making the handle too complicated. If the handle 2 is insecurely retained, it becomes a safety hazard. In the operational adjustment, the strips 2b and the slots 3b are not completely separated, thereby resulting in wear or damage of the strips 2b and the slots 3b, due to the mechanical friction.

### SUMMARY OF THE INVENTION

The primary objective of the present invention is to provide a handle retaining structure which can be easily adjusted and is highly stable.

It is another objective of the present invention to provide a handle retaining structure which is durable.

The handle retaining structure comprises a handle, a fastening seat, a locating device. The handle has a first retaining portion. The fastening seat has a first carrying seat for receiving the first retaining portion. The locating device is joined with the fastening seat and is formed of a joining portion, a second retaining portion, and an adjustment portion. The joining portion has a second carrying seat for joining with the first joining seat and for receiving the first retaining portion. The second retaining portion and the first retaining portion are complementary to each other. The adjustment portion is intended to enable the first retaining portion and the second retaining portion to engage or disengage with each other.

### BRIEF DESCRIPTION OF THE DRAWINGS

FIG. 1 shows an exploded view of a handle retaining structure of the prior art.

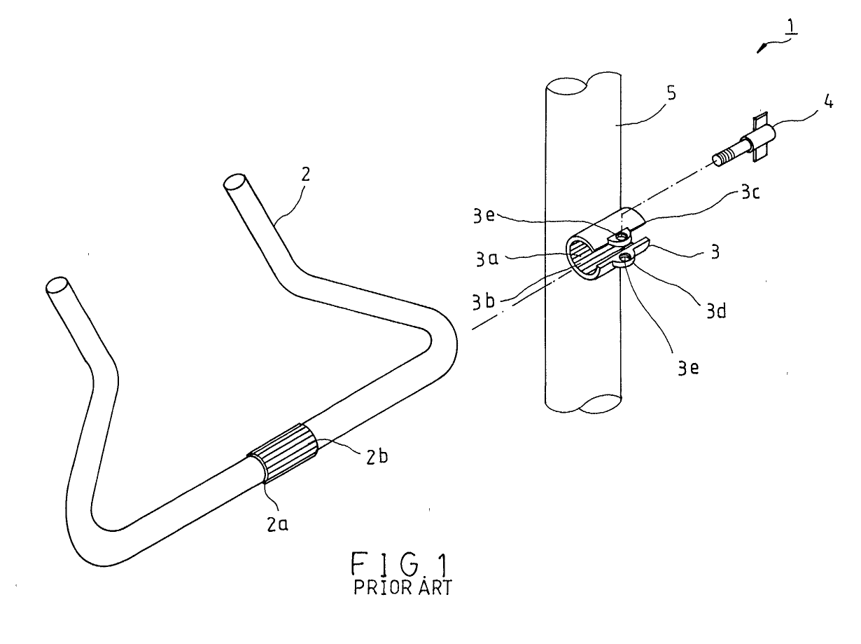

FIG. 2 shows an exploded view of a first preferred embodiment of the present invention.

FIG. 3 shows a perspective view of the first preferred embodiment of the present invention in combination.

FIG. 4 shows a sectional view of the first preferred embodiment of the present invention.

FIG. 5 shows an exploded view of a second preferred embodiment of the present invention.

FIG. 6 shows a sectional view of the second preferred embodiment of the present invention.

FIG. 7 shows a schematic view of the second preferred embodiment of the present invention in action.

### DETAILED DESCRIPTION OF THE INVENTION

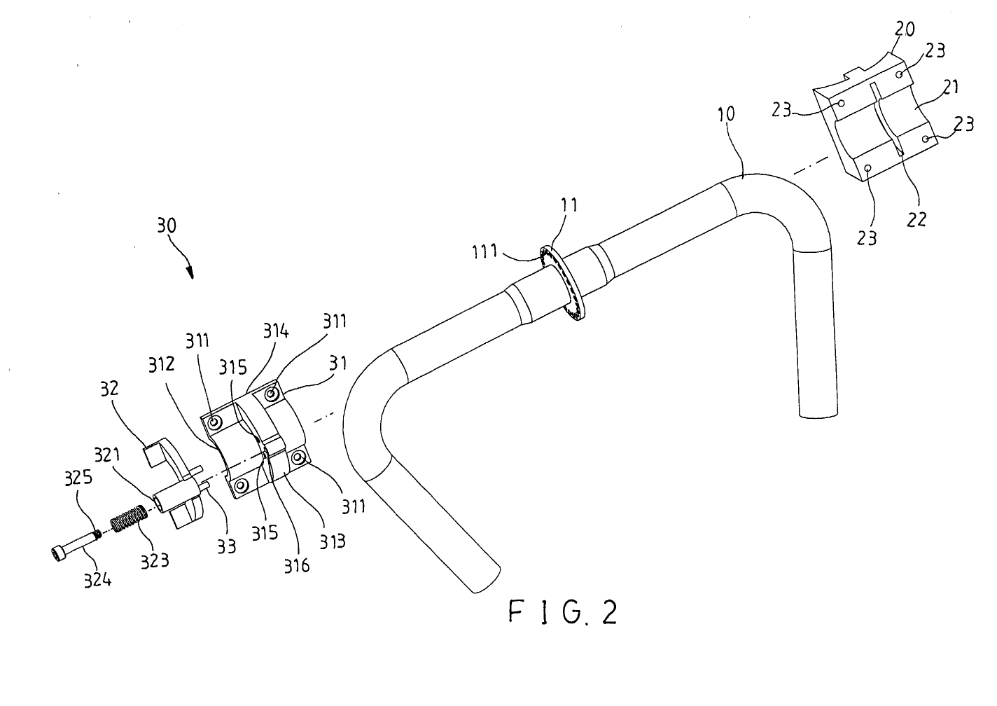

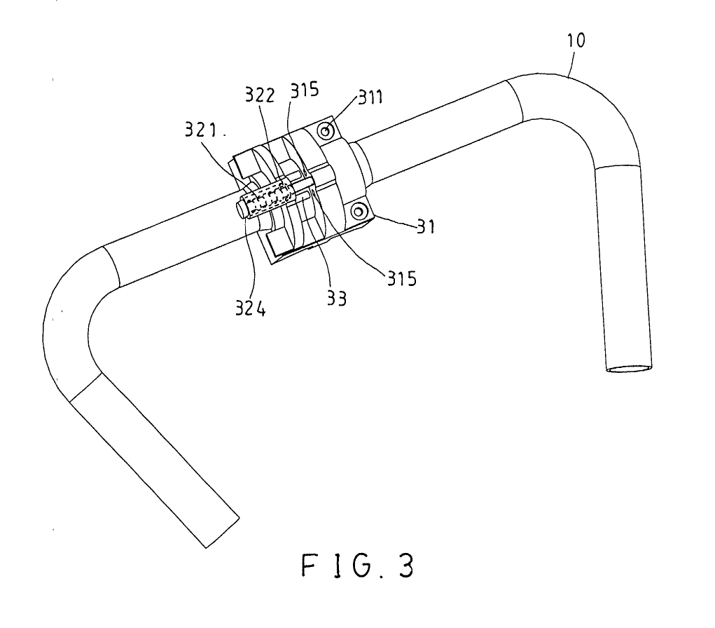

As shown in FIGS. 2-3, a handle retaining structure A embodied in the present invention comprises a handle 10, a fastening seat 20, and a locating device 30.

The handle 10 is cylindrical and is provided with two grips. The handle 10 has a first retaining portion 11 located in the periphery of the midsegment thereof and provided with a plurality of locating holes 111 which are arranged at an interval around the axis of the first retaining portion 11 such that they penetrate through both ends of the first retaining portion 11.

The fastening seat 20 has a first receiving slot 21, a first carrying seat 22, and a first connection portion 23. The first receiving slot 21 is located in one end disposed in the midsegment of the first receiving slot 21 and is perpendicular to the first receiving slot 21. The first connection portion 23 is formed of four recess holes which are disposed in the fastening seat 20.

The locating device 30 comprises a joining portion 31, an adjustment portion 32, and two second retaining portions33.

The joining portion 31 has a second connection portion 311, a second receiving slot 312, and a protruded rib 313. The second connection portion 311 is disposed in one end of the joining portion 31 and is opposite to the first connection portion 23. The fastening seat 20 and the joining portion 31 are fastened by screws. The second receiving slot 312 is disposed in one end of the joining portion 31, with its internal profile being the same as the outer profile of the handle 10. After the joining portion 31 and the fastening seat 20 are joined together, a space is formed between the second receiving slot 312 and the first receiving slot 21 for receiving the handle 10. The protruded rib 313 is disposed in other end of the joining portion 31 and is provided therein with a second carrying seat 314 perpendicular to the second receiving slot 312, with its internal profile being the same as the external profile of the first retaining portion 11. A space is formed between the second carrying seat 314 and the first carrying seat 22 for receiving the first retaining portion 11. The protruded rib 313 further has two through holes 315 and a lock hole 316. The through holes 315 are disposed in the outer portion of the protruded rib 313 and in communication with the second carrying seat 314 and can be corresponding in location to the locating hole 111 of the first retaining portion 11. The lock hole 316 is disposed in the outer portion of the protruded rib 313 and is located with the through holes 315 on the same end such that the lock hole 316 is not in communication with the second carrying seat 314.

The adjustment portion 32 has a receiving hole 321 and is provided in the inner wall thereof with a stop portion 322. A spring member 323 is disposed in the receiving hole 321 such that one end thereof is in contact with the stop portion 322. A lock member 324 is disposed in the spring member 323 and has one end with an outer diameter greater than the inner diameter of the spring member 323. The lock member 324 is capable of contacting other end of the spring member 323. The other end of the lock member 324 has a lock section 325 extending out of the receiving hole 321 and capable of being locked in the lock hole 316 of the joining portion 31.

The second retaining portion 33 is located in the adjustment portion 32 and is complementary in shape to the locating hole 111. As the lock member 324 is locked in the lock hole 316, the second retaining portion 33 is jutted out of the receiving hole 315 to extend into the locating hole 111, so as to locate the handle 10.

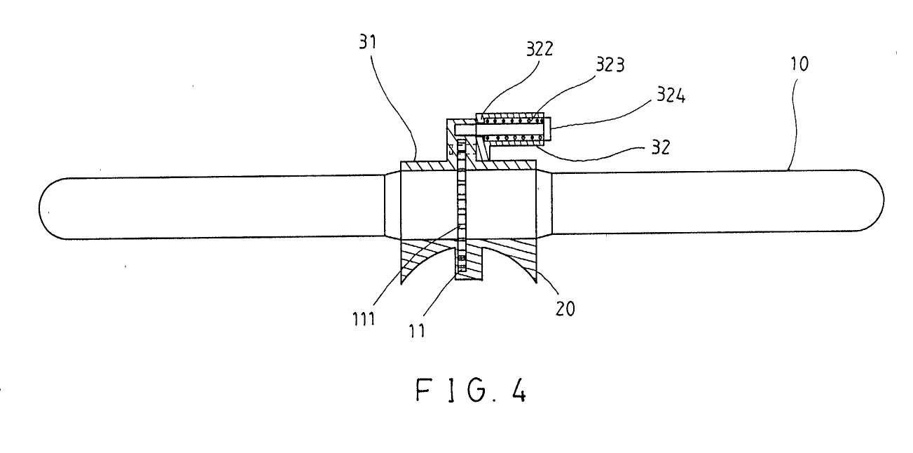

As shown in FIG. 4, the angular adjustment of the handle 10 is done by pulling the adjustment portion 32 away from the joining portion 31, thereby causing the spring member 323 to be pulled by the lock member 324 so as to deform. The deformity enables the lock member 324 to pull the joining portion 31 for a distance. As a result, the second retaining portion 33 is moved out of the locating hole 111 of the first retaining portion 11. The handle 10 can be turned to adjust its angle. The handle 10 is located by letting the handle 10 go. The adjustment portion 32 is thus caused by the counterreaction force of the recovery force of the deformed spring member 323 to return to its original position. The second retaining portion 33 is once again located in the locating hole 111, so as to locate the handle 10.

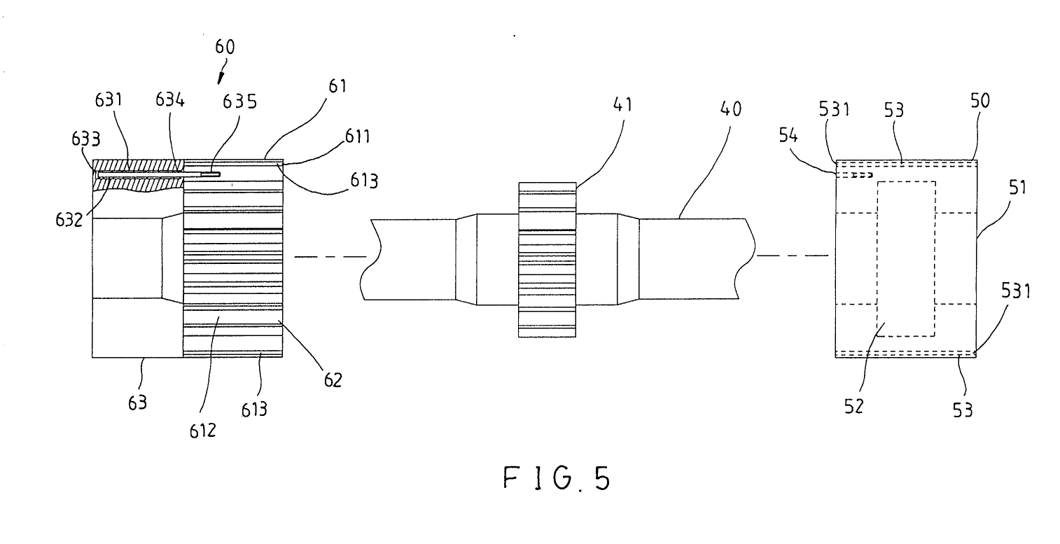

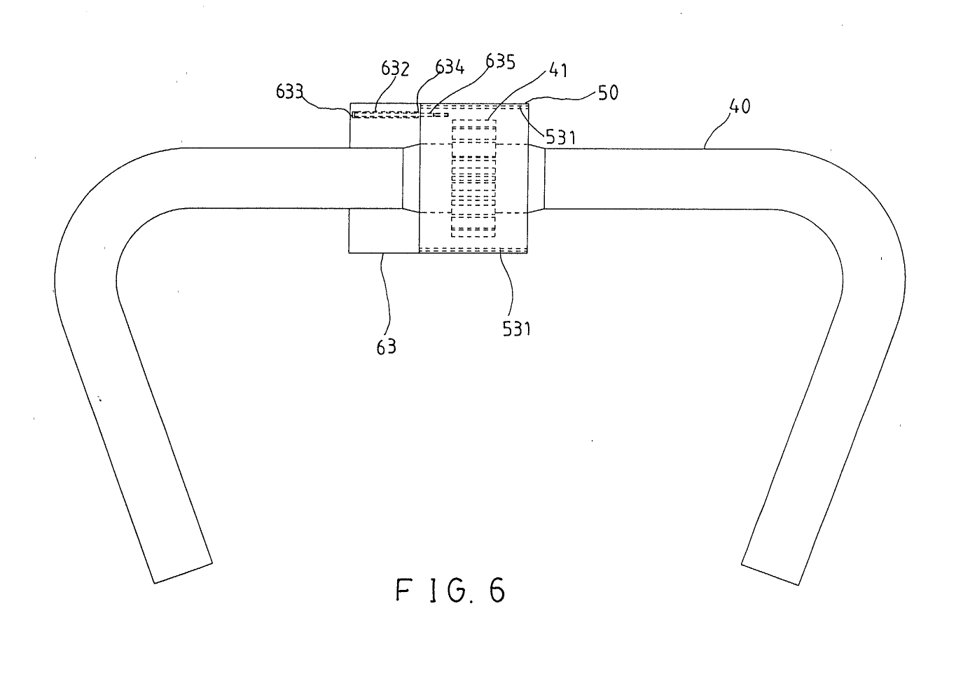

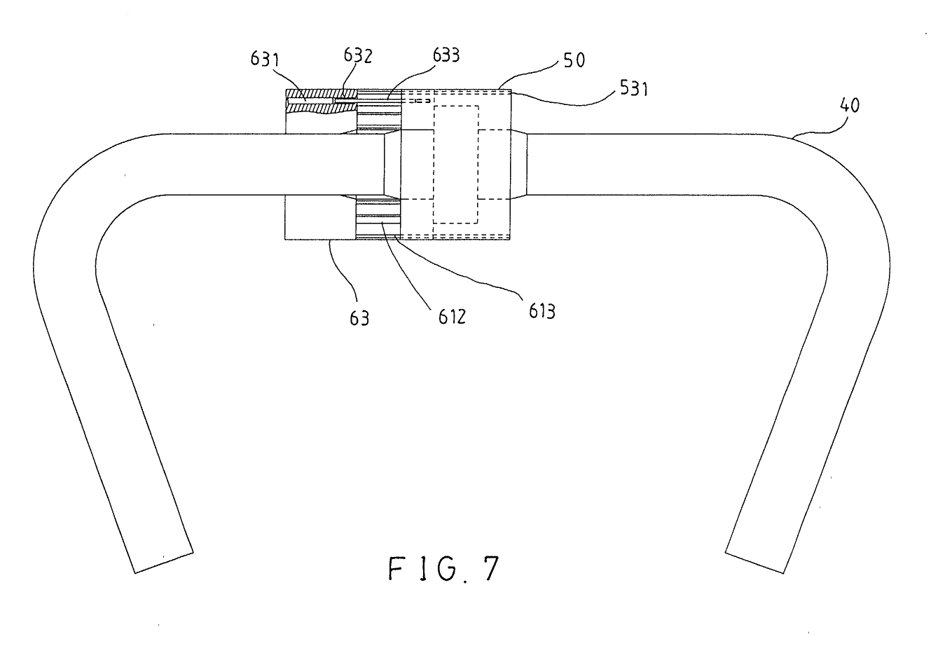

As shown in FIGS. 5-7, a handle retaining structure B of the second preferred embodiment of the present invention comprises the following components.

A handle 40 has a first retaining portion 41 which is circularly arranged in the outer periphery of the midsegment of the handle 40 and is provided in the outer profile with a plurality of toothed slots.

A fastening seat 50 has a first receiving slot 51 which is disposed in one end of the fastening seat 50 for receiving the handle 40. A first carrying seat 52 is disposed in the midsegment of the first receiving slot 51 and in a vertical state. A first connection portion 53 is disposed in two end surfaces and is formed as a linear slot 531. A lock hole 54 is disposed in one side of the fastening seat 50.

A locating device 60 comprises a joining portion 61, a second retaining portion 62, and an adjustment portion 63. The joining portion 61 has a second connection portion 611 and a second carrying seat 612. The second connection portion 611 is disposed on two end surfaces of the joining portion 61 to form a linear rail 613 corresponding to the first connection portion 53 for joining with the linear slot 531 of the first connection portion 53. The second carrying seat 612 and the first carrying seat 52 form a space for receiving the first retaining portion 41.

The second retaining portion 62 is disposed in the inner wall of the second carrying seat 612 and is complementary to the first retaining portion 41 which is retained by the second retaining portion 62.

The adjustment portion 63 is extended downward from the joining portion 61 and is provided with a receiving hole 631, a spring member 632, and a lock member 633. The receiving hole 631 is provided therein with a stop portion 634. The spring member 632 is disposed in the receiving hole 631 such that one end of the spring member 632 is in contact with the stop portion 634. The lock member 633 is disposed in the spring member 632 and has one end with an outer diameter greater than the inner diameter of the spring member 632. The lock member 633 has other end which has a lock section 635 extending out of the receiving hole 631, so as to be locked in the lock hole 54 of the fastening seat 50.

The angle of the handle 40 is adjusted by pulling the locating device 60 to enable the adjustment portion 63 to be pulled outward. The spring member 632 is thus pulled by lock member 633 to deform, thereby pulling the locating device 60 away from the fastening seat 50. The second retaining portion 62 is disengaged with the first retaining portion 41. As a result, the handle 40 can be turned for angular adjustment. As the locating device 60 is let go, the handle 40 is located. The locating device 60 is forced by the recovery force of the spring member 632 to return to its original position. The second retaining portion 62 and the first retaining portion 41 are once again engaged with each other.

The first retaining portion and the second retaining portion of the present invention are slidably engaged or disengaged so as to ensure the retaining stability of the present invention. The first and the second retaining portions are disengaged at the time when the handle is angularly adjusted, thereby preventing the wear of these two retaining portions.

What is claimed is:

1. A handle retaining structure comprising:
a handle having a first retaining portion;
a fastening seat having a first carrying seat which is disposed in one end of the fastening seat for receiving said first retaining portion;
a locating device joined with said fastening seat and composed of a joining portion, a second retaining portion, and an adjustment portion, said joining portion provided with a second carrying seat which is disposed in one end of said joining portion for receiving said first retaining portion, said second retaining portion being complementary in profile to said first retaining portion, said adjustment portion intended for said first retaining portion and said second retaining portion to engage or disengage slidably.

2. The handle retaining structure as defined in claim 1, wherein said adjustment portion is further provided with a receiving hole which is provided in the inner wall with a stop portion, a spring force disposed in said receiving hole such that one end of said spring force is in contact with said stop portion, a lock member disposed in said spring force such that one end of said lock member is in contact with other end of said spring force, and that other end of said lock member is jutted out of said adjustment portion.

3. The handle retaining structure as defined in claim 1, wherein sad fastening seat further has a first connection portion which is formed of four recessed holes; wherein said joining portion further has a second connection portion disposed in one end of said joining portion to be opposite to said first connection portion; wherein said fastening seat and said joining portion are fastened by a screw.

4. The handle retaining structure as defined in claim 2, wherein said first retaining portion is circularly arranged on outer periphery of the midsegment thereof and is provided with a plurality of locating holes circumventing the axis of said first retaining portion; wherein said second retaining portion is disposed on one end of said adjustment portion and is complementary in shape to said locating hole.

5. The handle retaining structure as defined in claim 4, wherein said joining portion is provided with a protruded rib which is in turn provided with two receiving holes and a lock hole, said receiving holes being in communication with said second carrying seat and corresponding to said locating hole of said first retaining portion, said lock hole being disposed on said protruded rib without being in communication with said second carrying seat, said second retaining portion being extended out of the through hole at such time when said lock member of said adjustment portion is locked in said lock hole.

6. The handle retaining structure as defined in claim 1, wherein said fastening seat is provided with a first connection portion of a linear slot form; wherein said joining portion is provided with a second connection portion of a linear rail form and corresponding to said first connection portion for joining with said linear slot of said first connection portion.

7. The handle retaining structure as defined in claim 1, wherein said first retaining portion is circularly arranged on the outer periphery of the midsegment of said handle and is provided in the outer profile thereof with a plurality of toothed slots; wherein said second retaining portion is disposed in the inner wall of said second carrying seat and is complementary in profile to said first retaining portion for locating said first retaining portion.
